(19) United States
(12) Patent Application Publication
(10) Pub. No.: US 2023/0396458 A1
(43) Pub. Date: Dec. 7, 2023

(54) Apparatus and method for managing an online meeting

(71) Applicant: CANON U.S.A., INC., MELVILLE, NY (US)

(72) Inventors: Shingo Murata, Mineola, NY (US); Stephanie Suzuki, Irvine, CA (US); Attaullah Seikh, Irvine, CA (US)

(21) Appl. No.: 18/329,989

(22) Filed: Jun. 6, 2023

Related U.S. Application Data
(60) Provisional application No. 63/349,756, filed on Jun. 7, 2022.

(51) Int. Cl. H04L 12/18; H04L 9/40

(52) U.S. Cl. CPC H04L 12/1822; H04L 63/08

(57) ABSTRACT

A communication apparatus is provided and is configured to send an access request to a meeting control apparatus providing control functions for the online meeting; generate a client ID after passing authentication process executed according to the access request; send a connection request including the client ID to the meeting control apparatus, and control, after connecting between the communication apparatus and the meeting control apparatus based on the connection request, the online meeting using the control functions provided by the meeting control apparatus.

### CROSS REFERENCE TO RELATED APPLICATIONS

This application claims priority from U.S. Provisional Patent Application Ser. No. 63/349,756 filed on Jun. 7, 2022, the entirety of which is incorporated herein by reference.

### FIELD

The present disclosure relates generally to authentication used in bidirectional audio visual communication performed over a communication network.

### DESCRIPTION OF RELATED ART

Online meeting services such as Teams, Zoom, and Skype are known. Typically, during an online meeting using such services, each attendee is able to join the meeting, leave the meeting, and use a chatting function or other functions that the online meeting service provides.

In an online meeting, it is useful if control rights for controlling aspects of the online meeting are assigned to a specific computer (e.g. a laptop computer, a tablet computer, or a smartphone). This way, the specific computer can perform meeting management processes such as starting the meeting, stopping the meeting, managing the attendees and/or defining regions of interest corresponding to objects or surfaces that are available for view to meeting participants. However, if there are many authorized computers having the control rights for the same online meeting, the attendees may be confused. This may result in different control actions being performed and cause the meeting to be disjointed and not properly function as a collaboration sessions between the meeting participants as intended.

### SUMMARY

A communication apparatus is provided and remedies the drawbacks described above. The communication apparatus comprises one or more processors and one or more memories storing instructions that, when executed, configures the one or more processors, to send an access request to a meeting control apparatus providing control functions for the online meeting; generate a client ID after passing authentication process executed according to the access request; send a connection request including the client ID to the meeting control apparatus, and control, after connecting between the communication apparatus and the meeting control apparatus based on the connection request, the online meeting using the control functions provided by the meeting control apparatus.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

FIG. 1 is a block diagram of illustrating a system architecture of the present disclosure.

FIG. 2 is a sequence diagram of illustrating process of the present disclosure.

FIG. 3 is a sequence diagram of illustrating process of the present disclosure.

FIGS. 4A-4C and 5 are user interface displays of the present disclosure.

FIG. 6 is a block diagram detailing the hardware components of an apparatus that executes the algorithm according to the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DETAILED DESCRIPTION

Exemplary embodiments of the present disclosure will be described in detail below with reference to the accompanying drawings. It is to be noted that the following exemplary embodiment is merely one example for implementing the present disclosure and can be appropriately modified or changed depending on individual constructions and various conditions of apparatuses to which the present disclosure is applied. Thus, the present disclosure is in no way limited to the following exemplary embodiment and, according to the Figures and embodiments described below, embodiments described can be applied/performed in situations other than the situations described below as examples.

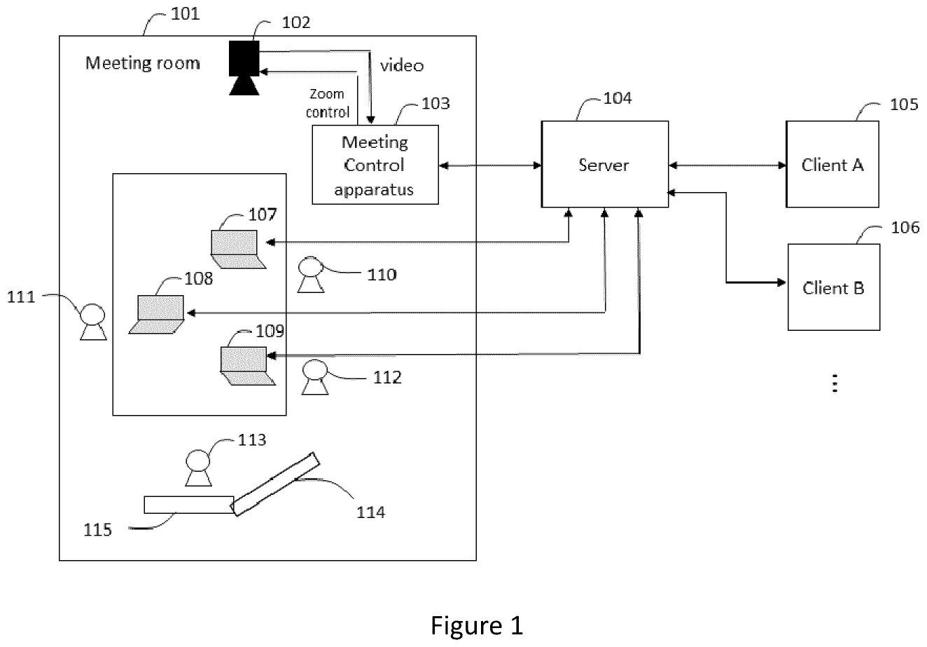

FIG. 1 illustrates a system architecture according to an exemplary embodiment. The system includes a camera 102, a meeting control apparatus 103, a server 104, a client computer A 105, a client computer B 106 and communication apparatuses 107-109. The communication apparatuses 107-109 may be a laptop computer, a tablet computer, a smartphone or other type of computer, and each of the communication apparatuses 107-109 may be operated by each of attendees 110-112.

As shown in FIG. 1, the Client A 105 and the Client B 106 attend, via a communication network, an online meeting held in the meeting room 101. In this embodiment, the camera 102, the meeting control apparatus 103, the communication apparatuses 107-109, the attendees 110-112, a presenter 113 and White boards 114-115 may be present in the meeting room 101 but this is not seen to be limiting. For example, the meeting control apparatus 103 can be located in the cloud.

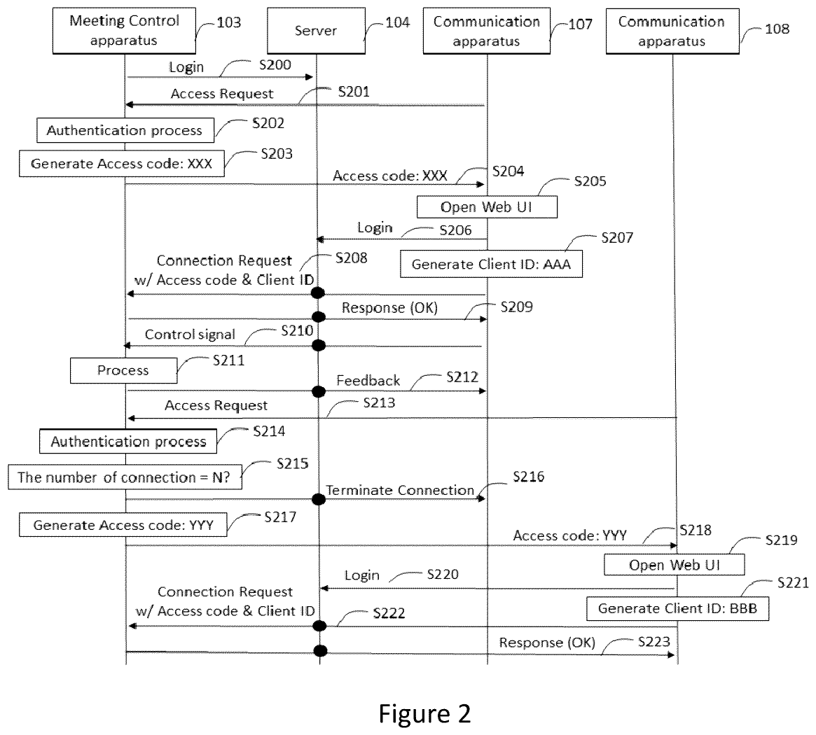

FIG. 2 is a sequence diagram illustrating processing performed by the meeting control apparatus 103, the server 104, and the communication apparatuses 107-108 according to an exemplary embodiment. The processing of the exemplary embodiment will be described in detail below with reference to FIGS. 1 and 2. In this embodiment, the process described with reference to FIG. 2 may be started in response to a trigger event detected by the communication apparatus 107 whereby a user operation is detected and requests use of one or more online meeting control functions provided by the meeting control apparatus 103. In an exemplary embodiment, when a browser of the communication apparatus 107 accesses a predefined URL (Uniform Resource Locator) and a certain image element on the webpage is selected (e.g. clicked or tapped), then the process of FIG. 2 is started.

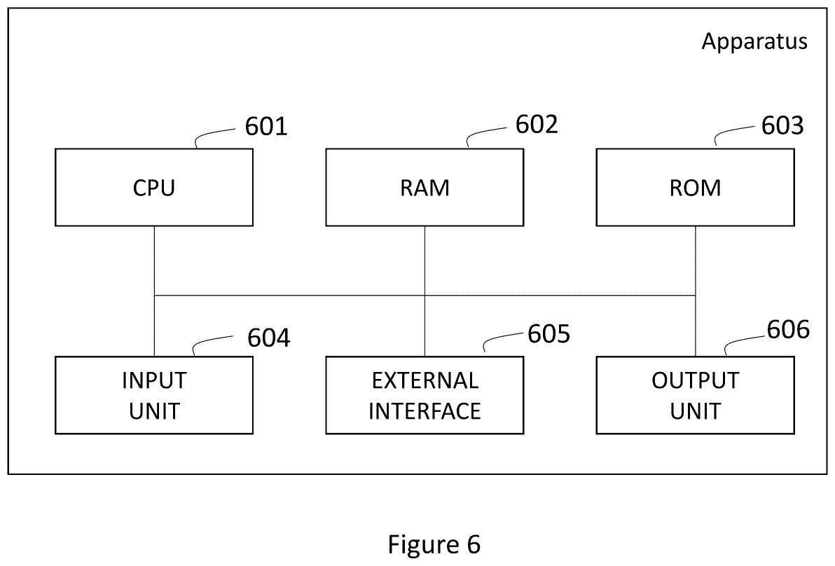

However, this is not seen to be limiting. For example, the operation reference to FIG. 2 may be started by predefined hand gestures, voice controls or keyboard operations by a user of the communication apparatus 107. Also, each step described with reference to FIG. 2 is executed by one of the meeting control apparatus 103, the server 104, the communication apparatuses 107 and 108. Each of these components include respective processing units (e.g. one or more CPUs 601 such as those shown in the hardware block diagram of FIG. 6) that reads and executes a set of instructions such as a pre-determined program stored in one or more memories (ROM 603). Note that the meeting control apparatus 103 has logged in to the server 104 in advance to starting the process of FIG. 2 in this embodiment, as shown by S200.

In S201, the communication apparatus 107 sends an access request to the meeting control apparatus 103 that is configured to provide control functions for the online meeting. In S202, the meeting control apparatus 103 performs authentication process for the communication apparatus 107 to determine whether the communication apparatus 107 is authorized to access to the meeting control apparatus 103. In an exemplary embodiment, the meeting control apparatus 103 determines if a user of the communication apparatus 107 which sent the access request exists in the meeting room 101 by using camera 102, and if the meeting control apparatus 107 determines that the user is present in the meeting room 101, authentication by the meeting control apparatus 103 is determined to be successful. However, the authentication method is not seen to be limiting.

For example, the meeting control apparatus 103 may display a password on a display screen in the meeting room 101, and if the password is correctly entered into the communication apparatus 107, the authentication process may be determined as successful. When the authentication process is successful, the process proceeds to the next step. In S203, the meeting control apparatus 103 generates an access code: XXX for the communication apparatus 107. In S204, the access code: XXX is provided to the communication apparatus 107. This access code: XXX is used by the communication apparatus 107 to establish a connection with the meeting control apparatus 103.

In S205, upon receiving the access code: XXX, the communication apparatus 107 opens a predetermined user interface (hereinafter, this is called “Web UI”) for controlling the online meeting. In S206, the communication apparatus 107 logs-in to the server 104 using a user ID: WebClient_{AccessCode: XXX}, and in S207, the communication apparatus 107 generates a client ID: AAA. In other words, the communication apparatus 107 generates the client ID after passing the authentication process performed by the meeting control apparatus 103 in S202.

In S208, the communication apparatus 107 sends, via the server 104, a connection request to the meeting control apparatus 103 for establishing a connection with the meeting control apparatus 103. The connection request includes the access code: XXX and the client ID: AAA. In S209, the meeting control apparatus 103 sends, via the server 104, a response to the communication apparatus 107 and the connection between the meeting control apparatus 103 and the communication apparatus 107 may be established in this step.

After establishing the connection between the meeting apparatus 103 and the communication apparatus 107, the communication apparatus 107 may send, via the server 104, a control signal based on a user operation on the meeting control apparatus 103 to control the online meeting in S210.

In S211, the meeting control apparatus 103 performs control process according to the control signal from the communication apparatus 107. In an exemplary embodiment, the meeting control apparatus 103 provides the control functions including at least one of (i) starting and/or stopping the online meeting, (ii) adding and/or deleting an attendee of the online meeting, (iii) zoom control for the camera 102 in the meeting room 101 and (iv) adding, editing and/or deleting a ROI (Region Of Interest).

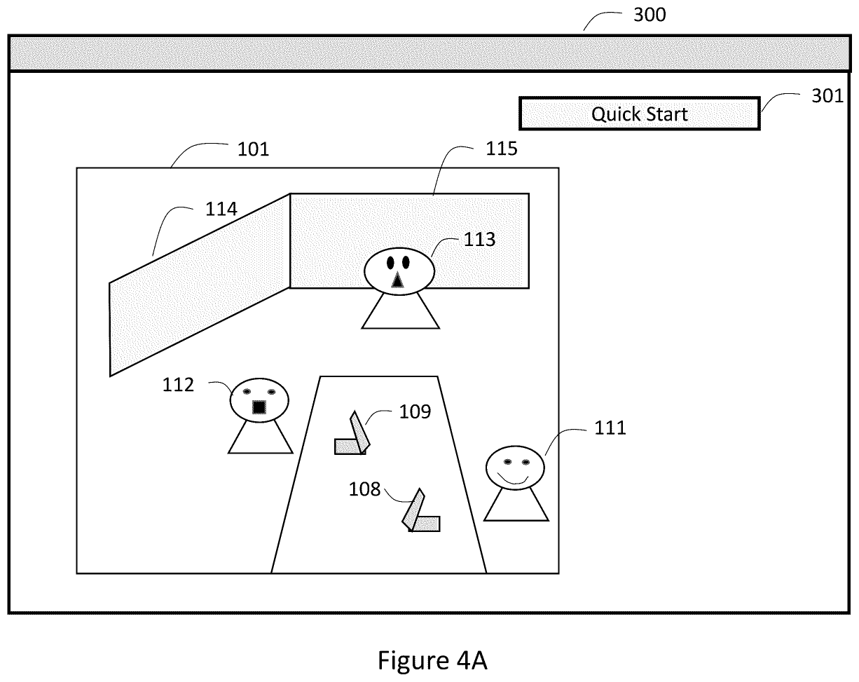

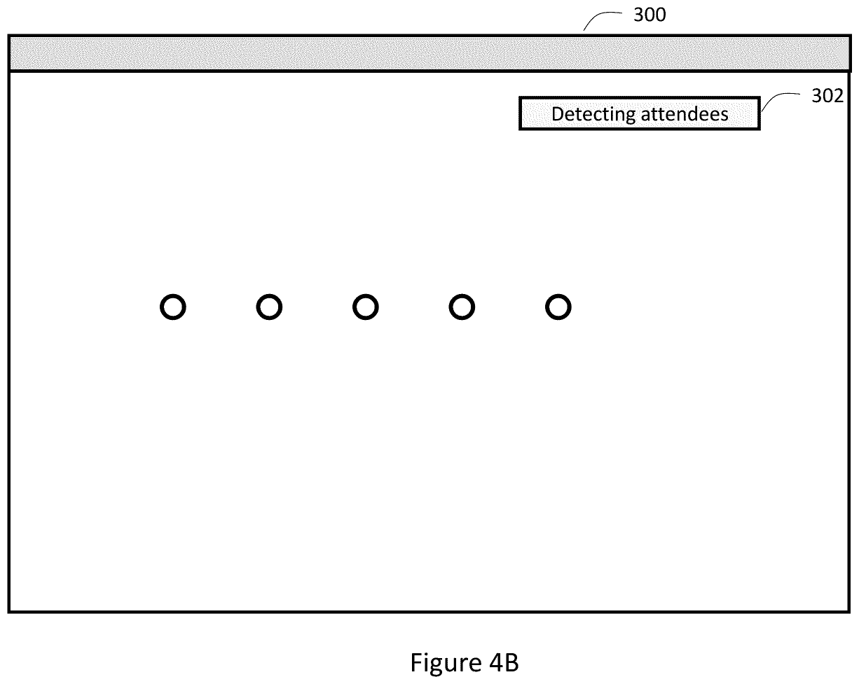

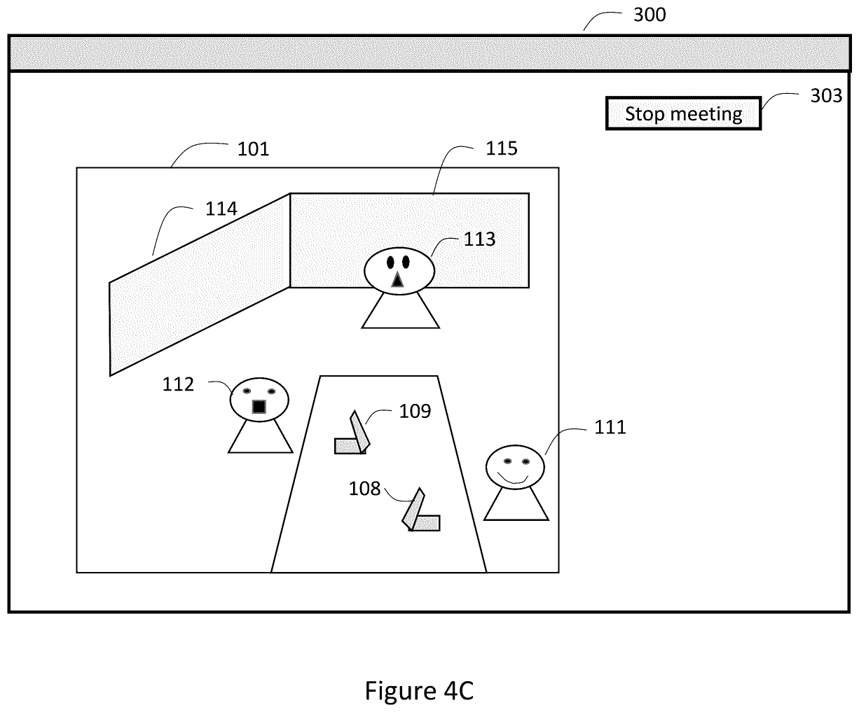

FIG. 4A illustrates a display screen 400 that the communication apparatus 107 displays in S208. The display screen 400 comprises a start button 401, and when the attendee 110 clicks the start button 401, then the communication apparatus 107 sends a control signal to the meeting control apparatus 103 for starting an online meeting. The meeting control apparatus 103 which received the control signal performs process for starting the online meeting. More specifically, the meeting control apparatus 103 may detect persons from images captured by the camera 102. As shown in FIG. 4B, the communication apparatus 107 displays the display screen 400 that comprises a status information 402 which provides a status in starting the online meeting. After starting the online meeting, the communication apparatus 107 displays the display screen 400 that comprises a stop button for stopping the online meeting as shown in FIG. 4C. The display screens 400 illustrated by FIGS. 4B and 4C are displayed according to a feedback signal from the meeting control apparatus 103 provided via the server 104 in S212.

In S213, another communication apparatus 108 sends an access request to the meeting control apparatus 103, and the meeting control apparatus 103 starts authentication process for the communication apparatus 108 in S214. If the meeting control apparatus 103 determines that the communication apparatus 108 passes the authentication process, the meeting control apparatus 103 determines whether the number of connections that have been established has reached a threshold value N in S215. In an exemplary embodiment, the threshold value N is 1, and the meeting control apparatus 103 currently has the connection with the communication apparatus 107, so the meeting control apparatus 103 determines that the number of connection has reached the threshold value N in S215, and the meeting control apparatus 103 sends a termination message for terminating the connection between the meeting control apparatus 103 and the communication apparatus 107 in S216.

However, the above S214-S216 is not seen to be limiting. For example, the meeting control apparatus 103 may be able to decline the access request received in S213 if the meeting control apparatus 103 has N number of connections with the other communication apparatuses.

In S217, the meeting control apparatus 103 generates an access code: YYY which is different from the access code: XXX for the communication apparatus 107. In S218, the access code: YYY is provided to the communication apparatus 108. The access code: XXX is no longer valid and the communication apparatus 107 may not be able to control the online meeting via the meeting control apparatus 103 after S217.

If the meeting control apparatus 103 determines in S215 that the number of connections has not reached the threshold value N, the meeting control apparatus 103 may skip S216 and S217, and the access code: XXX may be sent to the communication apparatus 108 in S218 such that the meeting control apparatus 103 can provide information to both of the communication apparatuses 107 and 108 using the same access code, as needed. In 219, upon receiving the access code: YYY, the communication apparatus 108 opens a predetermined user interface (Web UI) for controlling the online meeting. In S220, the communication apparatus 108 logs-in to the server 104 using a user ID: WebClient_{AccessCode: YYY}.

In S221, the communication apparatus 108 generates a client ID: BBB. In other words, the communication apparatus 108 generates the client ID that is different from the client ID: AAA of the communication apparatus 107.

In S222, the communication apparatus 108 sends, via the server 104, a connection request to the meeting control apparatus 103 for establishing a connection with the meeting control apparatus 103. The connection request includes the access code: YYY and the client ID: BBB. In S223, the meeting control apparatus 103 sends, via the server 104, a response to the communication apparatus 108 and the connection between the meeting control apparatus 103 and the communication apparatus 108 may be established in this step.

After establishing the connection between the meeting apparatus 103 and the communication apparatus 108, the communication apparatus 108 may send a control signal based on a user operation on the meeting control apparatus 103 to control the online meeting in a similar manner to the description with reference to S210-S212.

In case that the threshold value N is 2 or greater value, the determination in S215 may be “No” and the meeting control apparatus 103 may have the connection with the communication apparatus 107 and the connection with the communication apparatus 108 concurrently in S223. In this case, if the meeting control apparatus 103 intends to send a message to both of the communication apparatuses 107 and 108, the meeting control apparatus 103 sends the message with a target “User ID=WebClient_{AccessCode: XXX}”. Since the user IDs of the communication apparatuses 107 and 108 are the same, the message is provided to both of the communication apparatuses 107 and 108.

On the other hand, if the meeting control apparatus 103 intends to send a message to a specific communication apparatus 107 among the connected communication apparatuses 107 and 108, the meeting apparatus 103 sends the message with a target “Client ID: AAA”. Since the client IDs of the communication apparatuses 107 and 108 are different from each other, the meeting apparatus 103 can send a message to the specific communication apparatus using the client ID.

In case that the threshold value N is 2 or greater value and the meeting control apparatus 103 determines that the number of connection has reached the threshold value N in S215, the meeting control apparatus 103 may generate another Access code different from the existing Access code to terminate all existing connections. More specifically, the meeting control apparatus 103 performs as the following in the situation where the threshold value N is 2:
(i) The meeting control apparatus 103 establishes a connection with the first communication apparatus and issues Access code: XXX.
(ii) The meeting control apparatus 103 establishes a connection with the second communication apparatus and issues Access code: XXX.
(iii) The meeting control apparatus 103 establishes a connection with the third communication apparatus and issues Access code: YYY to terminate the connections with the first and second communication apparatuses.

However, this is not seen to be limiting. For example, the meeting control apparatus 103 may be able to terminate the connection with the oldest communication apparatus and keep the existing Access code. In this example, the meeting control apparatus 103 performs as the following in the situation where the threshold value N is 2:
(i) The meeting control apparatus 103 establishes a connection with the first communication apparatus and issues Access code: XXX.
(ii) The meeting control apparatus 103 establishes a connection with the second communication apparatus and issues Access code: XXX.
(iii) The meeting control apparatus 103 establishes a connection with the third communication apparatus and terminate the connection with the first communication apparatus by sending a termination message to the first communication apparatus.
   The meeting control apparatus 103 keeps the existing Access code: XXX so that the second communication apparatus can continue to control the online meeting via the meeting control apparatus 103.

As another alternative, the meeting control apparatus 103 may be able to decline the access request from the new communication apparatus if the meeting control apparatus 103 determines that the number of connection has reached the threshold value N in S215. In this example, the meeting control apparatus 103 performs as the following in the situation where the threshold value N is 2:
(i) The meeting control apparatus 103 establishes a connection with the first communication apparatus and issues Access code: XXX.
(ii) The meeting control apparatus 103 establishes a connection with the second communication apparatus and issues Access code: XXX.
(iii) The meeting control apparatus 103 declines to establish a connection with the third communication apparatus and keeps the existing Access code: XXX.

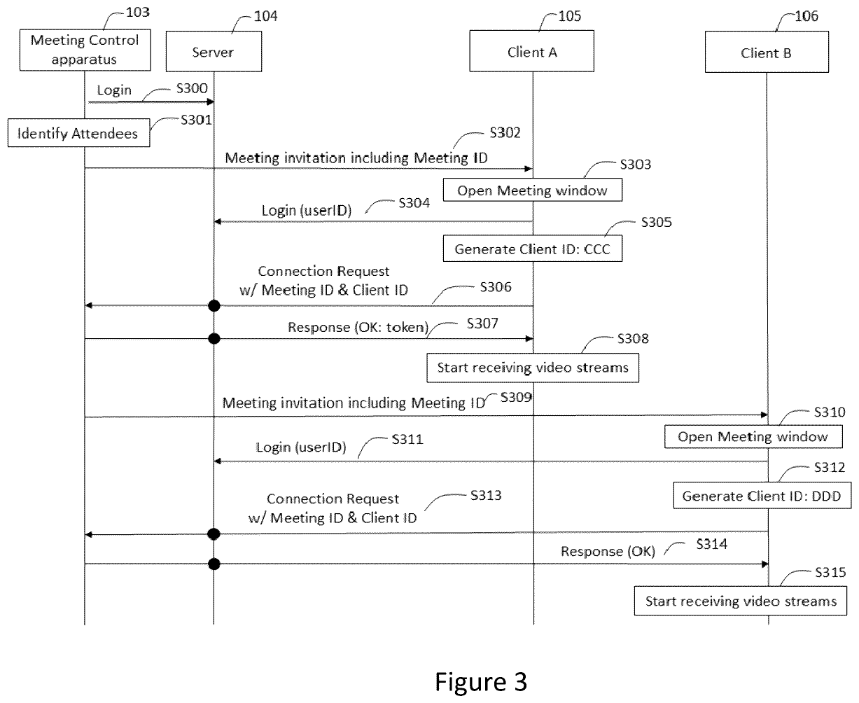

FIG. 3 is a sequence diagram illustrating process of the meeting control apparatus 103, the server 104, and the clients A 105 and B 106 according to an exemplary embodiment. As shown in FIG. 1, the clients A 105 and B 106 are located outside the meeting room 101 and attend an online meeting via a communication network. In an exemplary embodiment, the process described with reference to FIG. 3 may be started upon an instruction for starting an online meeting by clicking the start button 401 in FIG. 4A. Note that the meeting control apparatus 103 has logged in to the server 104 in advance to starting the process of FIG. 3 in this embodiment, as shown by S300.

In S301, the meeting control apparatus 103 identifies users (e.g. usernames) to be invited into the online meeting. In an exemplary embodiment, there are some options for identifying the users to be invited into the online meeting such as: (i) an operator of the meeting control apparatus 103 enters usernames into the meeting control apparatus 103, (ii) the user of the communication apparatus 107 that has established the connection with the meeting control apparatus 103 enters usernames into the communication apparatus 107 and provide the usernames to the meeting control apparatus 103 and/or (iii) the meeting control apparatus 103 performs facial recognition process on faces detected from an image captured by the camera 102 to identify usernames who is located in the meeting room 101.

In S302, the meeting control apparatus 103 sends an online meeting invitation to the client A 105 if a username A corresponding to the client A 105 is identified in S301. The online meeting invitation includes a certain identification information (hereinafter, this is called “Meeting ID”) that may be used by the client A 105 to establish a connection with the meeting control apparatus 103. Note that a format of the Meeting ID may be same with a format of the Access code.

The client A 105 which receives the online meeting invitation may display a new window that contains a predefined information (e.g. URL or Join button) for joining the online meeting in S303. If the user of the client A 105 clicks (or taps) the predefined information, the client A 105 may log-in to the server 104 using a user ID in S304. After logging-in, the client A 105 generates a Client ID: CCC in S305.

In S306, the client A 105 sends, via the server 104, a connection request for establishing a connection with the meeting control apparatus 103. In an exemplary embodiment, the connection request includes the Meeting ID and the Client ID.

In S307, the meeting control apparatus 103 determines, based on the Meeting ID and the Client ID: CCC included in the connection request, whether to establish the connection with the client A 105. If the meeting control apparatus 103 determines to establish the connection, the meeting control apparatus 103 sends, via the server 104, a notification for notifying the client A 105 of establishing the connection in S307. The notification includes a token, and the client A 105 includes the token into a video request sent to a video server to start receiving one or more video streams of an online meeting in S308.

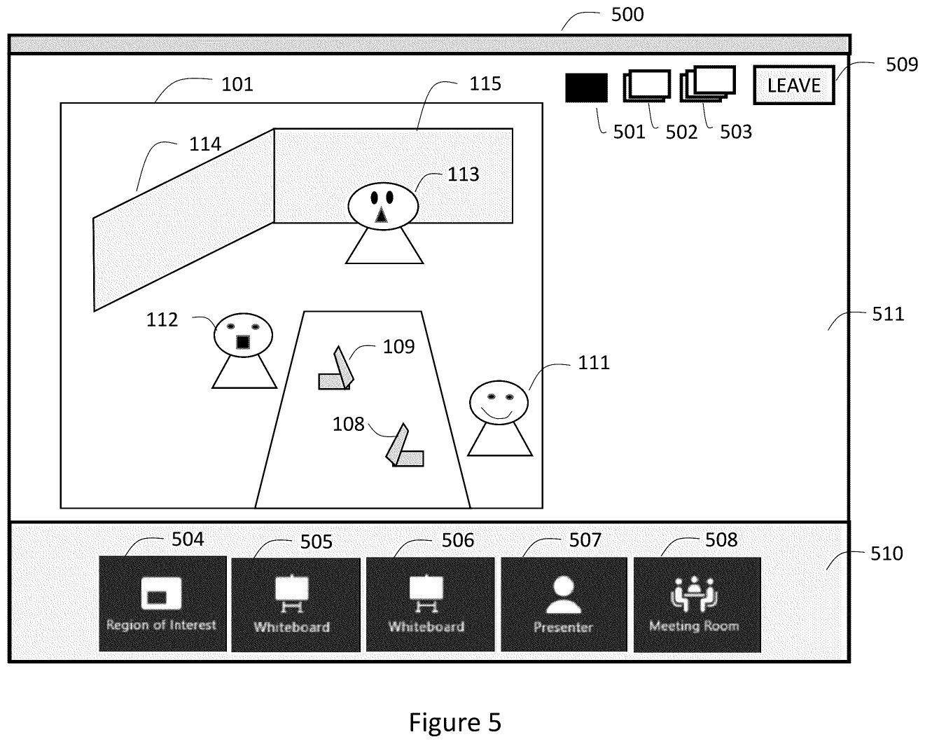

FIG. 5 illustrates the online meeting window 500 which is displayed in S308 of an exemplary embodiment. As FIG. 5 illustrates, the online meeting window 500 contains a single view indicator 501, a two view indicator 502, a three view indicator 503, video icons 504-508, and a leave button 509.

When the single view indicator 501 is selected by a user, a display region 511 may display one video as shown in FIG. 5. In the present exemplary embodiment, if the two view indicator 502 is selected, two videos may be displayed in the display region 511, and if the three view indicator 503 is selected, three videos may be displayed in the display region 511. The user of the client A 105 may choose any indicator from the indicators 501-503 to layout the online meeting window 500.

Also, the user of the client 105 may be able to choose one or more video icons among an ROI icon 504, a whiteboard icon A 505, a whiteboard icon B 506, a presenter icon 507 and a meeting room icon 508 which are located in a menu region 510. In the present exemplary embodiment, the choice is performed by a drag-and-drop operation on the video icon from the menu region 510 to the display region 511.

In S309, the meeting control apparatus 103 sends an online meeting invitation to the client B 106 upon identifying a new attendee to invite to the online meeting. The online meeting invitation includes the meeting ID which is same with the Meeting ID explained at S302. According to a user operation to the online meeting invitation, the client B 106 logs-in to the server 104 in S311, and the client B 106 generates a client ID: DDD in S312.

In S313, the client B 106 sends, via the server 104, a connection request for establishing a connection with the meeting control apparatus 103. The connection request includes the Meeting ID and the client ID: DDD. In S314, the meeting control apparatus 103 determines, based on the Meeting ID and the Client ID: DDD included in the connection request, whether to establish the connection with the client B 106. If the meeting control apparatus 103 determines to establish the connection, the meeting control apparatus 103 sends, via the server 104, a notification for notifying the client B 106 of establishing the connection in S314. The notification includes a token, and the client B 106 includes the token into a video request sent to the video server to start receiving one or more video streams of the online meeting in S315.

FIG. 6 illustrates the hardware that represents any of the camera 102, the meeting control apparatus 103, the server 104 and the communication apparatuses 107-109 that can be used in implementing the above described disclosure. The apparatus includes a CPU 601, a RAM 602, a ROM 603, an input unit, an external interface, and an output unit. The CPU 601 controls the apparatus by using a computer program (one or more series of stored instructions executable by the CPU 601) and data stored in the RAM 602 or ROM 603. Here, the apparatus may include one or more dedicated hardware or a graphics processing unit (GPU), which is different from the CPU 601, and the GPU or the dedicated hardware may perform a part of the processes by the CPU 601. As an example of the dedicated hardware, there are an application specific integrated circuit (ASIC), a field-programmable gate array (FPGA), and a digital signal processor (DSP), and the like. The RAM 602 temporarily stores the computer program or data read from the ROM 603, data supplied from outside via the external interface, and the like. The ROM 603 stores the computer program and data which do not need to be modified and which can control the base operation of the apparatus. The input unit is composed of, for example, a joystick, a jog dial, a touch panel, a keyboard, a mouse, or the like, and receives user's operation, and inputs various instructions to the CPU 601. The external interface communicates with external device such as PC, smartphone, camera and the like. The communication with the external devices may be performed by wire using a local area network (LAN) cable, a serial digital interface (SDI) cable, WIFI connection or the like, or may be performed wirelessly via an antenna. The output unit is composed of, for example, a display unit such as a display and a sound output unit such as a speaker, and displays a graphical user interface (GUI) and outputs a guiding sound so that the user can operate the apparatus as needed.

The scope of the present disclosure includes a non-transitory computer-readable medium storing instructions that, when executed by one or more processors, cause the one or more processors to perform one or more embodiments of the invention described herein. Examples of a computer-readable medium include a hard disk, a floppy disk, a magneto-optical disk (MO), a compact-disk read-only memory (CD-ROM), a compact disk recordable (CD-R), a CD-Rewritable (CD-RW), a digital versatile disk ROM (DVD-ROM), a DVD-RAM, a DVD-RW, a DVD+RW, magnetic tape, a nonvolatile memory card, and a ROM. Computer-executable instructions can also be supplied to the computer-readable storage medium by being downloaded via a network.

The use of the terms “a” and “an” and “the” and similar referents in the context of this disclosure describing one or more aspects of the disclosure (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter disclosed herein and does not pose a limitation on the scope of any disclosure derived from the disclosure unless otherwise claimed. No language in the specification should be construed as indicating any non-claimed element as essential.

It will be appreciated that the instant disclosure can be incorporated in the form of a variety of embodiments, only a few of which are disclosed herein. Variations of those embodiments may become apparent to those of ordinary skill in the art upon reading the foregoing description. Accordingly, this disclosure and any invention derived therefrom includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A communication apparatus for controlling an online meeting, the communication apparatus comprising:
one or more processors; and
one or more memories storing instructions that, when executed, configures the one or more processors, to:
send an access request to a meeting control apparatus that provides control functions for the online meeting;
generate a client ID after passing authentication processing executed according to the access request;
send a connection request including the client ID to the meeting control apparatus, and
control, after establishing a connection between the communication apparatus and the meeting control apparatus based on the connection request, the online meeting using the control functions provided by the meeting control apparatus.

2. The communication apparatus according to claim 1, wherein execution of the instructions further configures the one or more processors to
receive an access code from the meeting control apparatus after passing the authentication process, and
wherein the connection request includes the access code and the client ID.

3. The communication apparatus according to claim 1, wherein execution the instructions further configures the one or more processors to
login to a server using a user ID that is different from the client ID, and
wherein the connection request is sent to the meeting control apparatus via the server.

4. The communication apparatus according to claim 3, wherein the user ID of the communication apparatus is the same as a user ID of another communication apparatus that accesses to the meeting control apparatus.

5. The communication apparatus according to claim 4, wherein the client ID of the communication apparatus and a client ID of the other communication apparatus are different.

6. The communication apparatus according to claim 1, wherein the control functions for the online meeting that the meeting control apparatus provides include at least one of (i) starting and/or stopping the online meeting, (ii) adding and/or deleting an attendee of the online meeting, (iii) zoom control for a camera in a meeting room and (iv) adding, editing and/or deleting a Region Of Interest.

7. A meeting control apparatus that provides control functions for an online meeting, the apparatus comprising:
one or more processors; and
one or more memories storing instructions that, when executed, configures the one or more processors, to:
receive an access request from a communication apparatus;
execute, in response to the access request, authentication processing for the communication apparatus;
receive a connection request from the communication apparatus after the communication apparatus passes the authentication process;
control the online meeting based on a control signal received from the communication apparatus via a connection between the meeting control apparatus and the communication apparatus established based on the connection request.

8. The meeting control apparatus according to claim 7, wherein execution of the instructions further configures the one or more processors to
execute the authentication process for another communication apparatus in response to receiving an access request from the another communication apparatus after establishing the connection between the meeting control apparatus and the communication apparatus, and
terminate the connection between the meeting control apparatus and the communication apparatus in a case where the another communication apparatus passes the authentication process.

9. The meeting control apparatus according to claim 8, wherein execution of the instructions further configures the one or more processors to
provide an access code to the another communication apparatus if the another communication apparatus passes the authentication process, and
establish a connection between the meeting control apparatus and the another communication apparatus in response to receiving a connection request including the access code from the another communication apparatus such that the control for the online meeting is performed by a control signal from the another communication apparatus.

10. A communication method for controlling an online meeting, the method comprising:
sending an access request to a meeting control apparatus providing control functions for the online meeting;
generating a client ID after passing authentication process executed according to the access request;
sending a connection request including the client ID to the meeting control apparatus, and
controlling the online meeting using the control functions provided by the meeting control apparatus that is connected based on the connection request.

11. The communication method according to claim 10, further comprising:
receiving an access code from the meeting control apparatus after passing the authentication process, and
wherein the connection request includes the access code and the client ID.

12. The communication method according to claim 10, further comprising:
logging into a server using a user ID that is different from the client ID, and
wherein the connection request is sent to the meeting control apparatus via the server.

13. The communication method according to claim 12, wherein the user ID of the communication apparatus is the same as a user ID of another communication apparatus that accesses to the meeting control apparatus.

14. The communication method according to claim 13, wherein the client ID of the communication apparatus and a client ID of the other communication apparatus are different.

15. The communication method according to claim 10, wherein the control functions for the online meeting that the meeting control apparatus provides include at least one of (i) starting and/or stopping the online meeting, (ii) adding and/or deleting an attendee of the online meeting, (iii) zoom control for a camera in a meeting room and (iv) adding, editing and/or deleting a Region Of Interest.

16. A control method for controlling an online meeting, the method comprising:
receiving an access request from a communication apparatus;
executing, in response to the access request, authentication process for the communication apparatus;
receiving a connection request from the communication apparatus after the communication apparatus passes the authentication process;
controlling the online meeting based on a control signal received from the communication apparatus via a connection with the communication apparatus established based on the connection request.

17. The control method according to claim 16, further comprising:
executing the authentication process for another communication apparatus in response to receiving an access request from the another communication apparatus after establishing the connection between the meeting control apparatus and the communication apparatus, and
terminating the connection between the meeting control apparatus and the communication apparatus in a case where the another communication apparatus passes the authentication process.

18. The control method according to claim 17, further comprising:
providing an access code to the another communication apparatus if the another communication apparatus passes the authentication process, and
establishing a connection between the meeting control apparatus and the another communication apparatus in response to receiving a connection request including the access code from the another communication apparatus such that the control for the online meeting is performed by a control signal from the another communication apparatus.
